(19) United States
(12) Patent Application Publication
(10) Pub. No.: US 2024/0362375 A1
(43) Pub. Date: Oct. 31, 2024

(54) SOLVERS FOR INFRASTRUCTURE DESIGN AND OPTIMIZATION

(71) Applicant: HYPERLOOP TECHNOLOGIES, INC., Dubai (AE)

(72) Inventors: Mohammed Ismaeel BABUR, Temple City, CA (US); Yury SOKOLOV, La Mesa, CA (US); Dihan YANG, Alhambra, CA (US)

(21) Appl. No.: 18/645,278

(22) Filed: Apr. 24, 2024

Related U.S. Application Data
(60) Provisional application No. 63/462,936, filed on Apr. 28, 2023.

(51) Int. Cl. G06F 30/20; G06F 111/10

(52) U.S. Cl. CPC G06F 30/20; G06F 2111/10

(57) ABSTRACT

A computer-implemented method for optimizing an alignment between two points includes receiving a map of an area. The method also includes selecting a first solver from a group of solvers for optimizing an alignment between the two points in the map, each of the group of solvers is a machine learning solver. The method further includes generating a first optimal alignment between the two points based on the first solver minimizing a cost function associated with the two points.

### CROSS-REFERENCE TO RELATED APPLICATION

The present application claims the benefit of U.S. Provisional Patent Application No. 63/462,936, filed on Apr. 28, 2023, and titled “SOLVERS FOR INFRASTRUCTURE DESIGN AND OPTIMIZATION,” the disclosure of which is expressly incorporated by reference in its entirety.

### BACKGROUND

Infrastructure may be designed using software systems. In many cases, human users enter input to configure an alignment on terrain. For example, a civil engineer may design a corridor for power lines using a mouse and keyboard in a typical personal computer (PC) environment. Human-originated designs are often inefficient and, in some cases, dangerous to human lives. Therefore, having human-originated designs creates a risk, given that humans simply make mistakes when designing systems.

However, humans are adept at solving problems that cannot be easily addressed by artificial intelligence (“AI”). For example, a human designer may create a design for a railroad line in order to maximize the scenic view from the passenger coaches. In general, AI is not well-suited for problems of maximizing aesthetic value, as one example. Nevertheless, the human-originated design may not be optimized with respect to safety for use by humans (e.g., the scenic railroad line may pass over dangerous fault lines). Therefore, many industries use AI to augment human-originated designs.

### SUMMARY

In some aspects of the present disclosure, a method for optimizing an alignment between two points includes receiving a map of an area. The method further includes selecting a first solver from a group of solvers for optimizing an alignment between the two points in the map, each of the group of solvers is a machine learning solver. The method also includes generating a first optimal alignment between the two points based on the first solver minimizing a cost function associated with the two points.

Other aspects of the present disclosure are directed to an apparatus. The apparatus includes means for receiving a map of an area. The apparatus further includes means for selecting a first solver from a group of solvers for optimizing an alignment between the two points in the map, each of the group of solvers is a machine learning solver. The apparatus also includes means for generating a first optimal alignment between the two points based on the first solver minimizing a cost function associated with the two points.

In other aspects of the present disclosure, a non-transitory computer-readable medium with program code recorded thereon is disclosed. The program code is executed by one or more processors and includes program code to receive a map of an area. The program code still further includes program code to select a first solver from a group of solvers for optimizing an alignment between the two points in the map, each of the group of solvers is a machine learning solver. The program code also includes program code to generate a first optimal alignment between the two points based on the first solver minimizing a cost function associated with the two points.

Other aspects of the present disclosure are directed to an apparatus including one or more processors, and one or more memories coupled with the one or more processors and storing processor-executable code that, when executed by the one or more processors, is configured to cause the apparatus to receive a map of an area. Execution of the processor-executable code further causes the apparatus to select a first solver from a group of solvers for optimizing an alignment between the two points in the map, each of the group of solvers is a machine learning solver. Execution of the processor-executable code also causes the apparatus to generate a first optimal alignment between the two points based on the first solver minimizing a cost function associated with the two points.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

The accompanying drawings, which are incorporated herein and constitute part of this specification, illustrate exemplary aspects of the claims, and together with the general description given above and the detailed description given below, serve to explain the features of the claims.

FIG. 1 is a block diagram illustrating a bounding region.

FIG. 2A is a block diagram illustrating a geographic information system (“GIS”) management system.

FIG. 2B is a block diagram illustrating a cost map data structure and a cost layer data structure.

FIG. 2C is a block diagram illustrating a solver management system and a solver submodule.

FIG. 3A is a flowchart illustrating a process for a solver management system.

FIG. 3B is a flowchart illustrating a process for a solver management system.

FIG. 3C is a flowchart illustrating a process for a solver management system.

FIG. 4 is a block diagram illustrating an example computing device suitable for use with the various aspects described.

FIG. 5 is a block diagram illustrating an example server suitable for use with the various aspects described.

FIG. 6 is a flow diagram illustrating an example of a process for optimizing an alignment between two points, in accordance with various aspects of the present disclosure.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

As discussed, infrastructure may be designed using software systems. In many cases, human users enter input to configure an alignment on terrain. For example, a civil engineer may design a corridor for power lines using a mouse and keyboard in a typical personal computer (“PC”) environment. Human-originated designs are often inefficient and, in some cases, dangerous to human lives. Therefore, having human-originated designs creates a risk, given that humans simply make mistakes when designing systems.

However, humans are adept at solving problems that cannot be easily addressed by artificial intelligence (“AI”). For example, a human designer may create a design for a railroad line in order to maximize the scenic view from the passenger coaches. In general, AI is not well-suited for problems of maximizing aesthetic value, as one example. Nevertheless, the human-originated design may not be optimized with respect to safety for use by humans (e.g., the scenic railroad line may pass over dangerous fault lines).

Therefore, many industries use AI to augment human-originated designs. Typically, AI relies on a solver to reach a deterministic result. But one solver may not fit every scenario. Today, current AI relies on one solver to address a problem. As such, finding and using the correct solver for the correct application is critical to leveraging AI. And AI used for infrastructure is no exception.

Therefore, it may be desirable to provide a solution for selecting and executing one or more solvers to optimize a cost function that is generally related to infrastructure design and simulation.

Costs are generally comprised of more than one underlying cost. For example, acquiring land has a purchase price, which is one component of a cost. Another component of the cost may be the costs associated with construction on the acquired land. If the acquired land is difficult to traverse, then construction costs may be unusually high when compared to similarly priced parcels. In essence, two parcels may be similarly priced but have disparate costs when considered for infrastructure deployment. Therefore, cost evaluation needs to be comprehensive and deep to support AI-based optimizations.

Components of a cost are typically represented on two-dimensional (“2D”) maps. For example, a parcel map may have latitude and longitude coordinates of parcel boundaries. A cost map comprising land values may be overlaid upon the parcel map to observe land values. Further, a cost map comprising construction costs may be overlaid on the land value cost map. Cost layers may be combined in any conceivable order as well as with any number of individual cost layers. In one aspect, a particular cost layer may have a higher weight when compared to other cost layers.

In the industry today, artificial intelligence (“AI”) may traverse the cost map using a solver in order to find, what is considered, an optimized alignment. However, the real-world optimization, not the optimization relative to the AI, may not significantly improve the initial alignment. Thus, one solver may be effective and another may not. Therefore, it may be desirable to select an appropriate solver to identify an optimized solution. In some examples, identifying an optimal alignment between two or more nodes is an example of identifying the optimized solution.

Various aspects of the present disclosure are directed to using one or more solvers, from a group of solvers, to optimize an alignment for infrastructure that is represented as a 2D cost map. The solvers may be applied iteratively to arrive at an optimized solution-one not easily found using a single solver. Each solver may be an example of a machine learning model (e.g., AI solver).

In some examples, the one or more solvers may be benchmarked to increase a likelihood that more effective solvers are selected for the problem at hand. Benchmarking data (e.g., test data) may be generated in order to evaluate one solver against another. For example, a mountain pass cost map may comprise geographic information system (“GIS”) data that informs a solver as to the costs of traversal through the mountain pass. Many solvers may be benchmarked against tests in order to be compared to one another using substantially controlled test data (e.g., a cost associated with the mountain pass).

As shall be disclosed, the benefits of the disclosed solution include one or more of: decreasing time to market, increasing operating profit, decreasing power consumption, optimizing land use, increasing passenger and/or cargo throughput, protecting environmental resources, reducing pollution, reducing reliance on fossil fuels, preserving historical sites, preserving cultural sites, reducing capital costs of infrastructure, or increasing passenger safety.

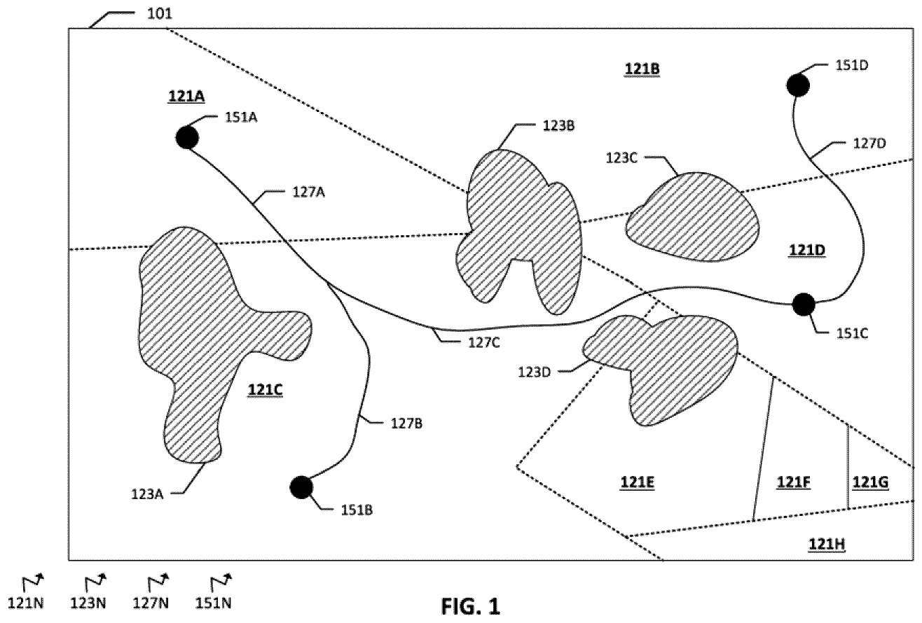

FIG. 1 is a block diagram illustrating a bounding region 101. The bounding region 101 comprises a plurality of parcels 121N, a plurality of obstructions 123N, a plurality of nodes 151A-151D, and a plurality of alignment curves 127N. In general, the bounding region 101 is associated with a real-world location. The bounding region 101 may be any conceivable shape—and is shown in the instant view as a simple rectangle. The disclosed solution is configured to optimize an alignment (or profile) of a corridor between two or more nodes 151A, 151B, 151C, and 151D within the bounding region 101.

A corridor is generally an area of land upon which infrastructure may be built. For instance, a corridor may support a road, a freeway, a tunnel, a railway, a hyperloop route, a high-speed rail route, an airport, power lines, gas lines, sewer lines, coastal walls, bridges, sea walls, or a combination thereof. The disclosed solution is configured to optimize an alignment curve that is associated with the corridor found in the bounding region 101.

The plurality of alignment curves 127N comprises a first alignment curve 127A, a second alignment curve 127B, a third alignment curve 127C, and a fourth alignment curve 127D. The plurality of alignment curves 127A may be comprised of optimized alignment curves and/or initial alignment curves. An initial alignment curve is generally one that has been created by a user or a process. In either case, the initial alignment curve is generally not optimized. On the other hand, an optimized alignment curve is optimized, as the name suggests. For example, the alignment curve 127A may be in an optimized state, whereas the alignment curve 127B is not optimized. The alignment curve 127A may be in the optimized state based on minimizing a cost function associated with the alignment curve 127A.

The plurality of parcels 121N comprises a first parcel 121A, a second parcel 121B, a third parcel 121C, a fourth parcel 121D, a fifth parcel 121E, a sixth parcel 121F, a seventh parcel 121G, and an eighth parcel 121H. The plurality of parcels 121N comprises varying cost values and thus impose different costs on plurality of alignment curves 127N. For example, the parcel 121C may be a marsh associated with high traversal costs when constructing roads.

The bounding region 101 comprises a plurality of obstructions 123N. The plurality of obstructions 123N comprises a first obstruction 123A, a second obstruction 123B, a third obstruction 123C, and a fourth obstruction 123D. In general, the plurality of obstructions 123N may be anything that causes costs to be so high that traversal is simply not feasible. The disclosed solution is configured to account for the plurality of obstructions 123N when developing an optimized configuration of the plurality of alignment curves 127N. For instance, the best-suited solver(s) may be selected to address the plurality of obstructions 123N in the bounding region 101.

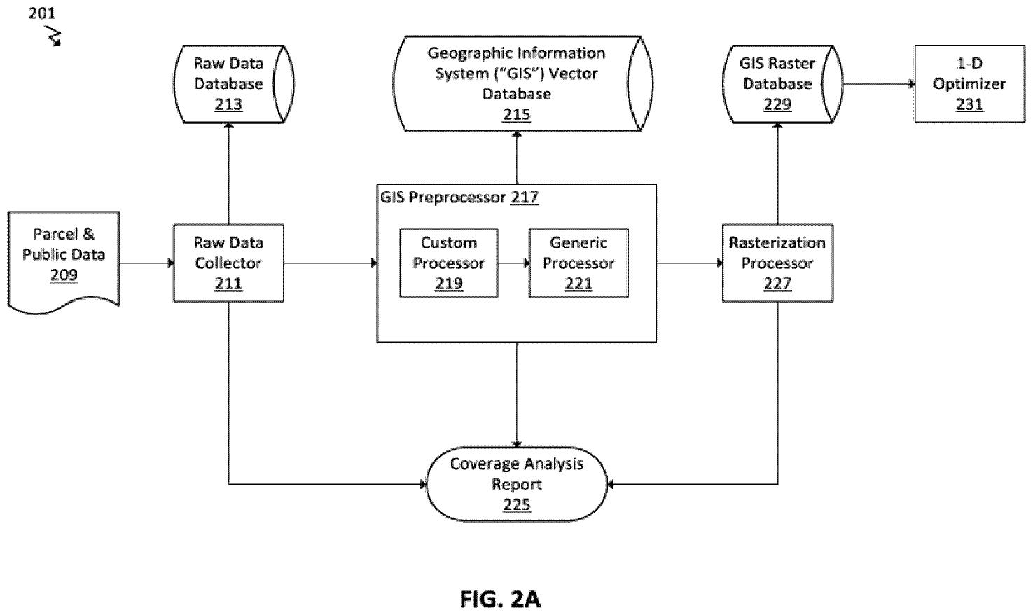

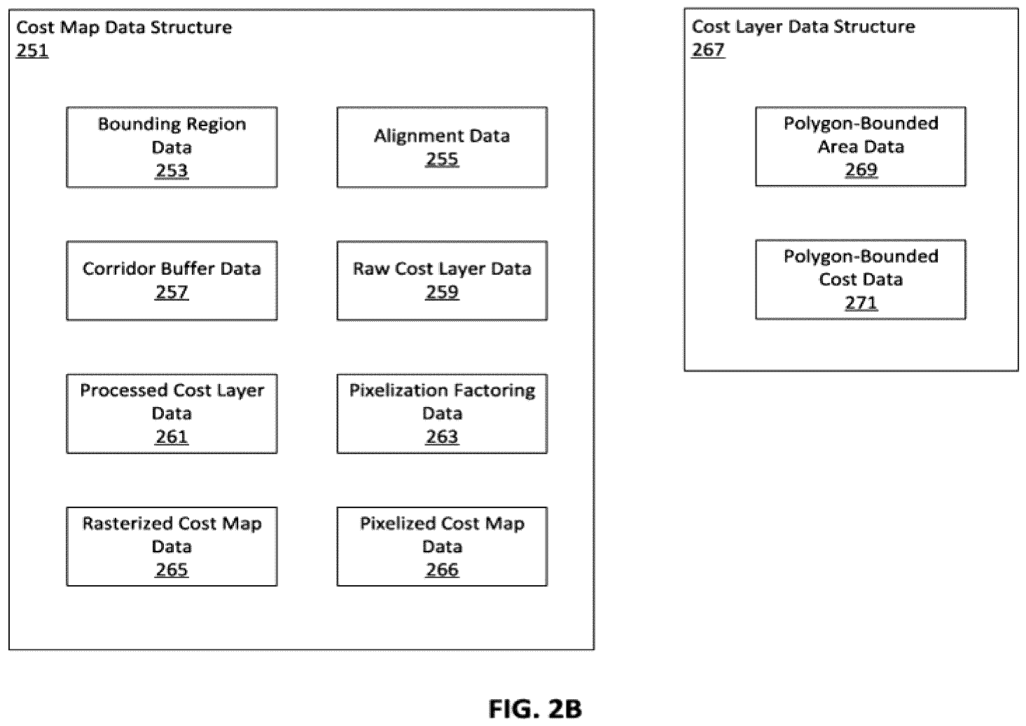

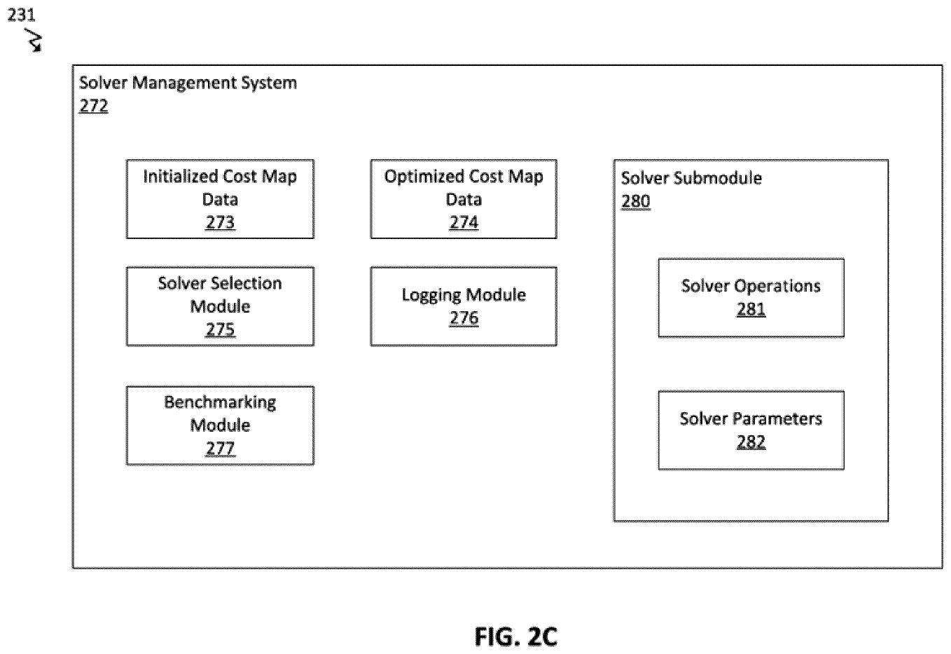

FIG. 2A is a block diagram illustrating a geographic information system (“GIS”) management system 201. The GIS management system 201 is generally configured to provide GIS information to a one-dimensional (“ID optimizer 231. A coverage analysis report 225 may also be generated by the GIS management system 201 for use by designers, civil engineers, operators, etc.

The 1D optimizer 231 is generally configured to optimize for a single parameter (e.g., one dimension) along a particular alignment. In general, the 1D optimizer 231 may create an optimal design in one dimension, in which that one dimension includes multiple design and configuration parameters. For example, the 1D optimizer 231 may optimize a vertical profile of an alignment to reduce capital expenditure costs that are necessary to deploy a linear infrastructure route. The 1D optimizer 231 also accounts for vehicle acceleration limits, passenger acceleration limits, jerk limits, grade constraints (e.g., gradeability), motor acceleration, motor power capabilities, braking capabilities, thermal limits, etc. The 1D optimizer 231 may also consider parameters from other dimensions to understand some three-dimensional constraints.

The 1D optimizer 231 may rely on local multivariate optimization for a piecewise continuous spline with nonlinear constraints using a Broyden-Fletch-Goldfarb-Shanno (“BFGS”) algorithm and/or a Sequential Least Squares Programming (“SLSQP”) algorithm. Optimization types for entities with multi-order continuity at the boundaries may include a genetic algorithm and/or a particle swarm algorithm. Depending on the context, one of skill in the art will appreciate that one or both algorithms may be utilized.

The 1D optimizer 231 is further configured to be utilized during trip simulations such that kinematic-related optimizations may be tested. For example, peak velocity may be selected as the trajectory (or drive strategy) to optimize; the trip simulation may then utilize and validate the 1D optimization of kinematics related to a hyperloop vehicle during operation. Likewise, the trip simulation may inform the ID optimizer 231 of any deficiencies discovered during the simulation, and/or be used to understand the full kinematic constraints to be considered for the 1D optimizer 231 to further optimize an alignment and profile. Alternative costs may be utilized as part of linear infrastructure deployment (e.g., such as those related to hyperloop).

The GIS management system 201 is configured to receive parcel and public data 209. The parcel and public data 209 may be parcel maps of land areas. In one aspect, the parcel maps may be augmented with prices indicating the value of the land (as well as any improvements thereto). The value of land may be considered by the 1D optimizer 231 when optimizing an alignment and profile. In one aspect, the parcel and public data 209 may be any public data relating to land value, land use, land prices, property taxes, ownership, encumbrances, historical status, environmental protection status, topography, utilities, geology, water bodies, vegetation, or maps based on certain analyses including flood maps, seismic risk maps, or the like. Such information may be utilized by the ID optimizer 231 in order to generate optimized alignments and potential profiles.

A raw data collector 211 is generally configured to configure and store data of various types and formats. One of skill in the art will appreciate that GIS data may be received in many different formats. For example, GIS data may be received as vectorized data or rasterized data. The raw data collector 211 processes disparate types of data. One of skill in the art will appreciate that such a benefit provides users with ease of use because various types of data may be aggregated and processed such that the user is free to focus on designing the hyperloop route.

A raw data database 213 is generally accessible by the raw data collector 211 in order to write or read raw GIS data. The raw data collector 211 is configured to output the raw GIS data to the coverage analysis report 225, such that a consumer of the coverage analysis report 225 may access the raw GIS data supporting other processed outputs (e.g., rasterizations). The coverage analysis report 225 contains the details of what factors and objectives were considered when determining an alignment and profile. For example, a linear infrastructure route may be optimized such that the linear infrastructure route traverses a plot of land. During eminent domain proceedings, the coverage analysis report 225 provides a detailed and objective source of information to support or refute an eminent domain claim.

The coverage analysis report 225 may be regenerated based on considerations uncovered as part of new events. For example, the coverage analysis report 225 may be regenerated during an eminent domain proceeding in order to arrive at a more optimized solution for stakeholders involved in the eminent domain proceedings. One of skill in the art will appreciate that the disclosed solution may arrive at the same optimization in many cases; nevertheless, the coverage analysis report 225 provides a critical source of information as to what data was considered when arriving at said same optimization.

A GIS preprocessor 217 comprises a custom processor 219 and a generic processor 221. The GIS preprocessor 217 is generally configured to preprocess the raw GIS data sent by the raw data collector 211. The raw GIS data may thereafter be considered preprocessed GIS data. The preprocessed GIS data may be written to the coverage analysis report 225 or to a GIS vector database 215. The GIS vector database 215 is accessible by the GIS preprocessor 217 in order to write or read preprocessed the vectorized data.

The custom processor 219 is generally configured to address situations where the cost of traversing a particular GIS data layer is unknown (or unsatisfactory for optimization). The GIS data layer may be manipulated such that a cost function may be derived for an optimization. For example, a GIS data layer for terrain may only include raw elevation data; the custom processor 219 may use the raw elevation data to generate a meaningful cost metric, such as a slope raster in order to have a slope cost function. As another example, a body of water represented in a GIS data layer may not have a cost function associated with crossing the body of water. Likewise, the custom processor 219 generates a cost function based on traversing the body of water via a tunnel or bridge. The output of the custom processor 219 is then communicated to the generic processor 221 for further operations (e.g., normalization).

The generic processor 221 is generally configured to normalize any cost functions in the GIS data layer. Often, the GIS data layer contains the necessary cost functions. For example, a terrain map may have associated therewith the prices of land. However, even with a cost function present, the GIS data layer may still need further normalization and processing prior to consumption by additional AI algorithms, systems, modules, etc.

A rasterization processor 227 is generally configured to receive the preprocessed GIS data from the GIS preprocessor 217. The rasterization processor 227 is configured to rasterize any data into an aggregated image with multiple raster bands. For example, the GIS data received from the GIS preprocessor 217 may be vectorized data. As such, the rasterization processor 227 may rasterize the vectorized data into a single image with multiple raster bands. Each raster band may be further placed in a data structure, such as a tree or other structure, based on the various resolutions of the raster bands (or the entire image itself), thus providing a user with the capability to explore the data in an efficient and responsive manner. The rasterization processor 227 is configured to output the rasterized GIS data to a GIS raster database 229. In one aspect, the GIS raster database 229 then communicates the rasterized GIS data to the ID optimizer 231.

FIG. 2B is a block diagram illustrating a cost map data structure 251 and a cost layer data structure 267. The cost map data structure 251 comprises bounding region data 253, alignment data 255, corridor buffer data 257, raw cost layer data 259, processed cost layer data 261, pixelization factoring data 263, rasterized cost map data 265, and pixelized cost map data 266. The cost layer data structure 267 comprises polygon-bounded area data 269 and polygon-bounded cost data 271.

The cost map data structure 251 is generally configured to encapsulate data relating to the 2D cost maps as well as metadata related thereto. The bounding region data 253 is generally configured to define a 2D array that represents the search space as well as the physical space beyond the search space. For example, a bounding region may be defined as an entire municipality in which an alignment is to be deployed. In one aspect, the 2D grid is defined by latitude and longitude coordinates, forming a bounding box.

The alignment data 255 is generally configured to represent one or more curves forming the alignment of a corridor. In one aspect, the alignment data 255 corresponds to the plurality of alignment curves 127N, shown in FIG. 1 above. The alignment data 255 is further configured to store additional metadata. For example, the alignment data 255 may comprise data that mathematically relates the alignment curves to one another.

In one aspect, the alignment data 255 may be initialized with an initial alignment in order to start subsequent operations relating to search space optimization. For example, initial alignment data may include a simple alignment within the bounding region. The simple alignment may be utilized to generate a corridor buffer that comprises the extent of the actual search space of the 1D optimizer 231.

One of skill in the art will appreciate that the alignment is distinct from the profile. For the purposes of the present disclosure, the alignment is of interest because the alignment generally defines where the profile will be deployed. In other words, the profile is generally configured to be overlaid on the ultimate alignment placement. Thus, the alignment data 255 may be updated and augmented to include additional data relating the alignment data 255 to any profile data (not shown). In one aspect, the alignment data 255 is augmented by the 1D optimizer 231 such that profile data may readily be associated with the alignment data 255.

The corridor buffer data 257 is generally configured to define a corridor at or near the initial alignment, as stored in the alignment data 255. As stated, the alignment data 255 may comprise initial alignment data within the bounding region data 253. The bounding region data 253 generally relates to the larger extent of the search space, and the corridor buffer data 257 is the more relevant area of the search space. As such, the 1D optimizer 231 is more efficient when determining optimized alignments (and even profiles). Thus, the initial alignment data forms the basis for corridor buffer data 257.

The raw cost layer data 259 is generally configured to store one or more layers containing cost-related data. For example, a parcel map may be included in a layer of the raw cost layer data 259 in order to demarcate the boundaries of various land parcels. Further, a land value map may be included as yet another layer of the raw cost layer data 259. As such, the cost map data structure 251 contains data sufficient to generate processed cost layer data 261, which is generally configured to provide the ID optimizer 231 the data for alignment optimization.

The processed cost layer data 261 is generally configured to store the raw cost layer data 259 after having been processed by the GIS management system 201 (and related processes). As stated, the 1D optimizer 231 is configured to perform advanced search and AI techniques on the processed cost layer data 261 in order to optimize the alignment data 255 further.

The pixelization factoring data 263 is generally configured to store data relating to pixelization techniques used to fill in gaps in the raw cost layer data 259 and/or the processed cost layer data 261. Thus, the pixelization factoring data 263 is such that pixelization operations may be controlled, managed, observed, optimized, etc.

The rasterized cost map data 265 is generally configured to provide a 2D array of data that represents the processed cost layer data 261. The rasterized cost map data 265 may be represented as a bitmap, in one aspect. Having the data represented in such a 2D array provides consolidated data that the 1D optimizer 231 may utilize to optimize the alignment data 255.

The pixelized cost map data 266 is generally configured to provide a 2D array of data that represents the processed cost layer data 261. One of skill in the art will appreciate that the rasterized cost map data 265 may have data gaps. In contrast, the pixelized cost map data 266 is configured to address any data gaps in the 2D array of the rasterized cost map data 265.

The cost layer data structure 267 is generally configured to store data relating to a real-world location. In general, the boundaries of the real-world locations are stored as polygons in the cost layer data structure 267. In one aspect, the raw cost layer data 259 and the processed cost layer data 261 utilize several cost layer data structures 267 in order to generate an optimized search space for consumption by the ID optimizer 231. In general, the cost layer data structure 267 instances will be represented in the resulting rasterized cost map data 265.

The polygon-bounded area data 269 is generally configured to store a plurality of coordinates, lines, vectors, rays, etc., any of which form a polygon-bounded region related to the real-world deployment of an alignment. For example, a polygon-bounded area may be a parcel of land that is available for purchase. As another example, a polygon-bounded area may be a nature preserve that is not available for deployment of infrastructure.

The polygon-bounded cost data 271 generally contains data relating to the cost of the polygon-bounded area within the polygon-bounded area data 269. As stated, cost is not simply monetary values required to traverse the polygon-bounded area with an alignment. Cost may include other resources required for an alignment to traverse a polygon-bounded area. For example, the cost may include the number of liters of water required to pour concrete within the polygon-bounded area.

FIG. 2C is a block diagram illustrating a solver management system 272 and a solver submodule 280. The solver management system 272 is generally configured to manage a plurality of solver submodules 280. The solver management system 272 comprises initialized cost map data 273, optimized cost map data 274, a solver selection module 275, a logging module 276, and a benchmarking module 277. The solver submodule 280 is generally configured to manage a particular solver and the associated configuration via one or more parameters. The solver submodule 280 comprises solver operations 281 and solver parameters 282.

The initialized cost map data 273 is generally configured to manage a cost map data structure 251 that is ready for one or more solver submodules 280 to be applied. In contrast, the optimized cost map data 274 is generally configured to manage an optimized instance of the initialized cost map data 273. For instance, solver operations 281 may process the initialized cost map data 273 in order to generate the optimized cost map data 274.

The solver selection module 275 is generally configured to manage one or more solver submodules 280. As such, one solver submodule 280 may be selected from many stored within the solver management system 272. The selection of a particular solver submodule 280 enables many use cases. One such use case is benchmarking one solver submodule 280 against another solver submodule 280. Another such use case is to use one or more solver submodules 280 to optimize the initialized cost map data 273. Still further, the solver selection module 275 may inform the logging module 276 as to the results and operations of the selected solver submodule 280.

The logging module 276 is generally configured to generate logging data. The disclosed solution provides an advantage by recording the various operations of one or more solvers. One such use of logging data is for human users to understand the operations of the solver management system 272. For instance, a human user may invoke many solver submodules 280 to test an optimization strategy. As part of that evaluation process, the human user may review the logging data in order to make adjustments to the strategy. Logging data may also include routine events such as exceptions, errors, warnings, memory faults, etc. Therefore, the logging data may be used for diagnostic and debugging purposes to utilize the solver management system 272 itself.

The benchmarking module 277 is generally configured to manage one or more benchmarks. The benchmarking module 277 comprises a plurality of benchmarking tests that may be applied to one or more solver submodules 280. For example, a benchmark test may be specified to determine an optimized alignment for underground power lines. The benchmarking module 277 may present the benchmarking test to the solver submodule 280 being tested—the performance of the solver submodule 280 is measured and reported to the logging module 276 in a report comprising logging data.

The solver submodule 280 is generally utilized to manage a particular solver. The solver management system 272, in turn, manage a group of solver submodules 280. The solver submodule 280 comprises the solver operations 281 which are generally configured to solve the initialized cost map data 273 to generate the optimized cost map data 274.

The disclosed solution relies on a number of solver operations 281 to achieve optimized results. Some exemplary solvers will be disclosed. However, one of skill in the art will appreciate that many solvers, not necessarily disclosed, may likewise be applicable to and utilized by various aspects of the present disclosure. The various aspects of the present disclosure may provide a benefit of selecting and executing any solver embodied in a solver submodule 280 as solver operations 281.

One solver submodule 280 is named the “interior-point solver” and relies upon nonlinear programming that finds the minimum of a problem specified by Formula 1 below. In some examples, the interior-point solver may be a configuration parameter that is passed to another solver, such as a fmincon solver in Matlab or a proprietary solver that may operate similarly to the fmincon solver. Formula 1 is as follows:

$${min}_{x} f ( x ) such that \{ \begin{matrix}c ( x ) \leq 0 \\ ceq ( x ) = 0 \\ A \cdot x \leq b \\ Aeq \cdot x = beq \\ lb \leq x \leq ub\end{matrix} , \qquad Formula 1 \text{:} Interior - Point Solver$$

$$where b and beq are vectors , A and Aeq are matrices , c ( x ) and ceq ( x ) are functions that return vectors , and f ( x ) is a function that returns a scalar . f ( x ) , c ( x ) , and ceq ( x ) may be non - linear functions . x , lb , and ub may be vectors or matrices .$$

The solver parameters 282 are generally configured to establish the behavior of the solver operations 281. For example, the maximum number of turns may be limited to a fixed number, as configured via the solver parameters 282. Such configuration enables the solver operations 281 to be configured according to real-world constraints. Further, such configurations enable a higher level of optimizations for solvers.

With respect to the interior-point solver, some exemplary solver parameters 282 appear in Table 1 below. One of skill in the art will appreciate that similar variables and constraints may be specified as part of the solver parameters 282.

TABLE 1
Interior-Point Solver Exemplary Solver Parameters 282

| Parameter Name | Value |
|---|---|
| Optimality Tolerance | e⁻⁷ |
| Constraint Tolerance | e⁻⁷ |
| Step Tolerance | e⁻⁷ |
| Specified Objective Gradient | True |
| Specified Constraint Gradient | True |
| Maximum Iterations | 500 |

The interior-point solver is particularly advantageous because the interior-point solver handles large, sparse problems as well as small, dense problems. Further, the interior-point solver bounds at many iterations and may readily recover from not-a-number and/or infinite results. In general, the benefits outweigh the disadvantages. For example, the interior-point solver generally has low memory use. However, the solutions of the solver may be slightly less accurate than other solutions derived by similar solver operations 281. One cause of the potential inaccuracy is that the internally calculated barrier function continues to iterate away from inequality constraint boundaries.

In order to reduce the inaccuracy of the interior-point solver, a number of approaches exist. First, the interior-point solver may be rerun with smaller values for the solver parameters 282 relating to: (1) step tolerance, (2) optimality tolerance, and (3) constraint tolerance. Second, a second solver may be applied that starts from the interior-point solver solution and proceeds to a second solution.

Another set of solver operations 281 is an active set algorithm (“ASA”). Often, penalty functions for constraints are used by solvers for constraints that are at or beyond a constraint boundary. However, approaches using Karush-Kuhn-Tucker (“KKT”) equations improve the efficiency of active set algorithm solvers. The KKT equations are necessary conditions for optimality for a constrained optimization problem. Further, the KKT equations are both necessary and sufficient for a global solution point within so-called convex programming problems.

Yet another set of solver operations 281 is based on sequential quadratic programming (“SQP”). SQP is similar to ASA, with some differences. SQP is a nonlinear programming method that closely mimics Newton-method-based operations. As such, SQP operations are constrained quasi-Newton methods, substantially guaranteeing super linear convergence by accumulating second-order information regarding KKT equations using quasi-Newton updating procedures.

At each major iteration, an approximation is made of the Hessian of the Lagrangian function using a quasi-Newton updating method. Once a quadratic programming (“QP”) subproblem is generated, the solution is used to form a search direction of a line search procedure. Thus, a formulation of a QP subproblem is based on a quadratic approximation of the Lagrangian function.

Other solver operations 280 include but are not limited to: trust-region reflective algorithms, precondition conjugate gradient algorithms, BFGS algorithm, L-BFGS-B algorithm, SLSQP algorithm, Nedler-Mead algorithm, Powell algorithm, conjugate gradient algorithm, Newton-CG algorithm, truncated Newton algorithm, constrained optimization BY linear approximation algorithm, dog-leg trust-region algorithm, Newton conjugate gradient trust-region algorithm, or a combination thereof. Irrespective of the particular solver operations 280, the disclosed solution enables the selection and application of many solvers beyond the scope of this document.

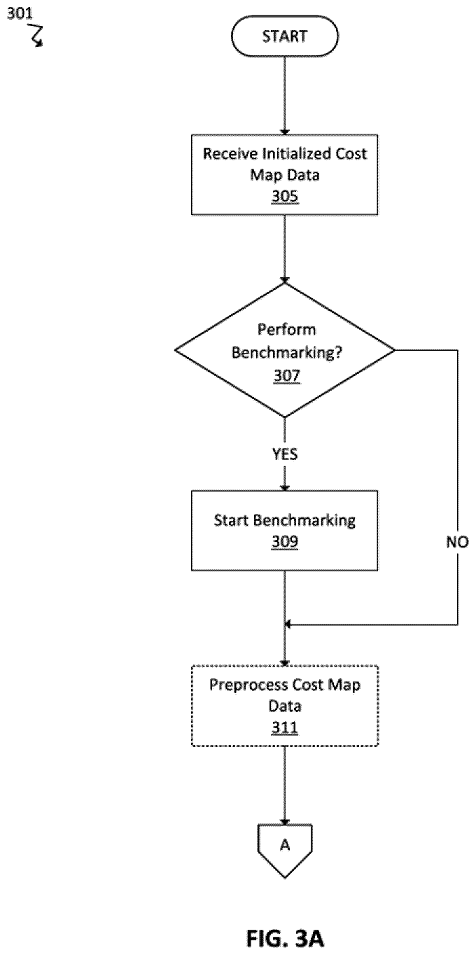

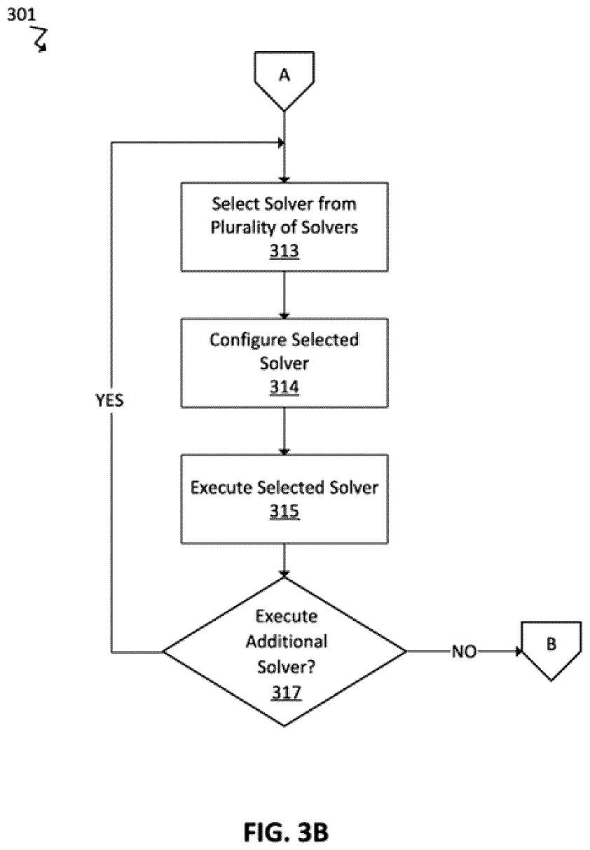

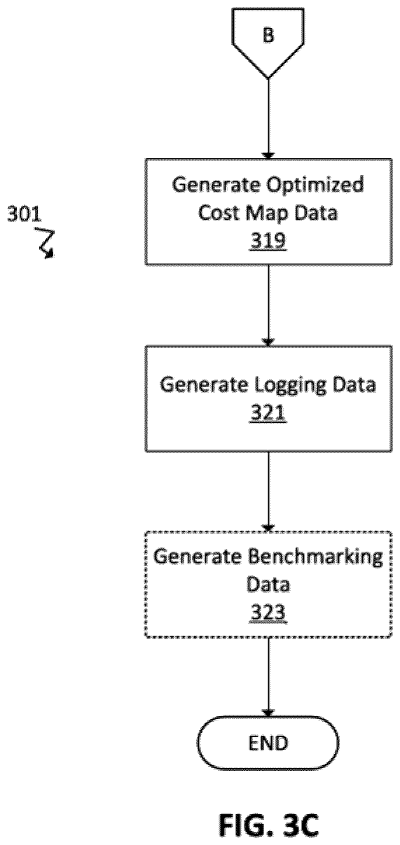

FIG. 3A is a flowchart illustrating a process 301 for the solver management system 272. The process 301 is generally configured to optimize an alignment using the solver management system 272. However, any 2D search space relating to infrastructure may be evaluated using the process 301.

In one aspect, initialized cost map data 273 may need processing in order to generate optimized cost map data 274. The process 301 is configured to generate such optimized cost map data 274 from initialized cost map data 273. In one aspect, the solver management system 272 is configured to be stored and executed within the 1D optimizer 231. Further, the solver submodule 280 may be stored and executed within the solver management system 272 (or generally as part of the 1D optimizer 231). The process 301 begins at the start block and proceeds to block 305.

At block 305, the process 301 receives initialized cost map data 273. In some examples, the initialized cost map data 273 may be associated with a map, in which one or more locations (e.g., grids) in the map are associated with a cost corresponding to the initialized cost map data 273. In one aspect, the process 301 receives the initialized cost map data 273 from the GIS raster database 229 as a particular cost map data structure 251. The initialized cost map data 273 comprises alignment data 255. In some examples, the alignment data 255 may be an example of initial alignment data that is initialized to a nominal configuration. The alignment data 255 indicates an alignment between two or more points in the map. For instance, a human operator may have hand-designed the alignment data 255 for a subway; however, optimization of the alignment data 255 may be specified in order for the subway to be resilient to seismic events (for example). That is, the process 301 may be specified to find a solver to optimize the alignment data 255 for a specific application, such as increasing resilience to a seismic event. The process 301 then proceeds to block 307.

At decision block 307, the process 301 determines whether to perform benchmarking. For example, a user may configure the process 301 to determine a best solver for a given application using test data. Likewise, benchmarking may be scheduled to update stakeholders as to the status of solver performance. If benchmarking is not to be performed, the process 301 proceeds along the NO branch to block 311. If the benchmarking is to be performed, the process 301 proceeds along the YES branch to block 309.

At block 309, the process 301 initializes a benchmarking procedure. In some examples, during the benchmarking procedure, the process 301 utilizes the benchmarking module 277 to monitor and record operations of one or more solver submodules 280. The process 301 may select one or more benchmark tests from the benchmarking module 277 to benchmark one or more solver submodules 280. The process 301 then proceeds to block 311.

At block 311, the process 301 preprocesses the cost map data. Block 311 is shown in dotted lines in order to emphasize that the preprocessing is optional. For example, the process 301 may normalize the cost map data as part of the preprocessing. In general, the initialized cost map data 273 is ready for application of a solver submodule 280. However, some preprocessing (e.g., normalization) may be performed on the initialized cost map data 273. The process 301 then proceeds to the off-page reference A and continues at FIG. 3B.

FIG. 3B is a flowchart illustrating the process 301 for the solver management system 272. The process 301 continues at the off-page reference A and proceeds to block 313.

At block 313, the process 301 selects a particular solver submodule 280 using the solver selection module 275. The solver management system 272 may have a number of solver submodules 280 under management. As such, the process 301 selects a particular solver submodule 280 to minimize a cost function associated with the optimized cost map data 274. For instance, the alignment data 255 may be such that the interior-point solver may be best suited to minimize a cost function to optimize the alignment data 255. As such, the interior-point solver is selected by the process 301 to optimize the alignment data 255. The process 301 then proceeds to block 314.

At block 314, the process 301 configures the selected solver submodule 280. For example, the solver parameters 282 may be configured as described in FIG. 2C above. The process 301 proceeds to block 315. At block 315, the process 301 executes the selected solver submodule. In some examples, a cost function is minimized using the selected solver submodule to generate an optimized an alignment between two or more points. That is, in some examples, the solver identifies a minimum of the cost function, subject to certain constraints, to optimize the infrastructure design. In the context of a cost map, the cost function represents a quantitative measure of the cost associated with a particular point or region (e.g., grid) in the map. As discussed, the cost map may be represented as a grid, where each element of the grid corresponds to a point or region in the map, and its value represents the associated cost corresponding to the cost map data.

Minimizing the cost function may be associated with finding lowest possible cost values in the cost map, subject to certain constraints. The constraints may include, but are not limited to, physical limitations of an environment and/or infrastructure, such as avoiding areas with high seismic activity or minimizing the cost of materials and labor. By minimizing the cost function, the optimization process may identify an alignment (e.g., design) that satisfies the given constraints. Additionally, or alternatively, the identified alignment may minimize the overall cost of the infrastructure project. After block 315, the process 301 proceeds to block 317.

At decision block 317, the process 301 determines whether to execute one or more other solvers (e.g., one or more other solver submodules 280). The determination may be algorithmically determined, in one aspect. In another aspect, the determination may be based on user input or other similar data sources. In yet another aspect, the determination may be based on the solver parameters 282. If the determination is to execute an additional solver submodule 280, the process 301 proceeds along the YES branch to block 313. If the determination is to not execute an additional solver, the process 301 proceeds along the NO branch to the off-page reference B which continues at FIG. 3C.

FIG. 3C is a flowchart illustrating the process 301 for the solver management system 272. The process 301 continues at the off-page reference B from FIG. 3C. The process 301 proceeds to block 319.

At block 319, the process 301 generates the optimized cost map data 274. The optimized cost map data 274 may include optimized alignment data between two or more points. The optimized cost map data 274 provides a more cost-efficient instance of the initialized cost map data 273. In other words, the optimized alignment data within the optimized cost map data 274 is more optimized than the initial alignment data 255 within the initialized cost map data 273.

Additional optimizations may be performed on the optimized cost map data 274. For example, a multidimensional optimizer may be applied to the optimized cost map data 274 in order to address other applications and/or constraints. The process 301 then proceeds to block 321.

At block 321, the process 301 generates logging data. The logging data may be useful to human users in order to configure the solver management system 272. Given the regulatory and safety requirements of infrastructure, logging data is critical for stakeholders to ascertain the safety of an infrastructure deployment. Therefore, the logging data provides information that enables the interpretation of the optimized cost map data 274 as well as the operations of the solver submodule 280. The process 301 then proceeds to block 323.

At block 323, the process 301 generates benchmarking data. Block 323 is bounded with a dotted line to indicate that the generating of the benchmarking data is contingent upon the decision block 307 and block 309, at FIG. 3A. The benchmarking data is such that one or more solver submodules 280 may be evaluated against a benchmark test. As such, the detailed metrics and analytics of the benchmark test are included in the benchmarking data.

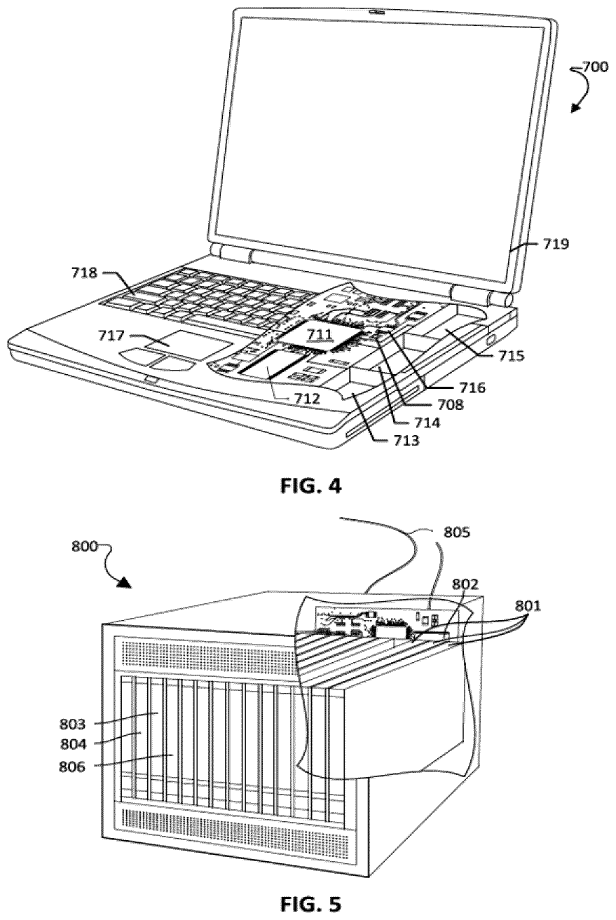

FIG. 4 is a block diagram illustrating a computing device 700 suitable for use with the various aspects described. The computing device 700 is configured to store and execute the GIS management system 201, the cost map data structure 251, the cost layer data structure 267, the solver management system 272, the solver submodule 280, and the process 301.

The computing device 700 may include a processor 711 (e.g., an ARM processor) coupled to volatile memory 712 (e.g., DRAM) and a large capacity nonvolatile memory 713 (e.g., a flash device). Additionally, the computing device 700 may have one or more antenna 708 for sending and receiving electromagnetic radiation that may be connected to a wireless data link and/or cellular telephone transceiver 716 coupled to the processor 711. The computing device 700 may also include an optical drive 714 and/or a removable disk drive 715 (e.g., removable flash memory) coupled to the processor 711.

The computing device 700 may include a touchpad touch surface 717 that serves as the computing device's 700 pointing device, and thus may receive drag, scroll, flick, or other gestures similar to those implemented on computing devices equipped with a touch screen display (not shown). In one aspect, the touchpad touch surface 717 may be integrated into one of the computing device's 700 components (e.g., a display 719). In one aspect, the computing device 700 may include a keyboard 718, which is operable to accept user input via one or more keys within the keyboard 718. In one configuration, the computing device's 700 housing includes the touchpad touch surface 717, the keyboard 718, and the display 719 all coupled to the processor 711. Other configurations of the computing device 700 may include a computer mouse coupled to the processor (e.g., via a USB input) as are well known, which may also be used in conjunction with the various aspects described.

FIG. 5 is a block diagram illustrating a server 800 suitable for use with the various aspects described. The computing device 700 is configured to store and execute the GIS management system 201, the cost map data structure 251, the cost layer data structure 267, the solver management system 272, the solver submodule 280, and the process 301.

The server 800 may include one or more processor assemblies 801 (e.g., an x86 processor) coupled to volatile memory 802 (e.g., DRAM) and a large capacity nonvolatile memory 804 (e.g., a magnetic disk drive, a flash disk drive, etc.). As illustrated in the instant figure, processor assemblies 801 may be added to the server 800 by insertion into the racks of the assembly. The server 800 may also include an optical drive 806 coupled to the processor assemblies 801. The server 800 may also include a network access interface 803 (e.g., an ethernet card, WIFI card, etc.) coupled to the processor assemblies 801 for establishing network interface connections with a network 805. The network 805 may be a local area network, the Internet, a public switched telephone network, and/or a cellular data network (e.g., LTE, 5G, etc.).

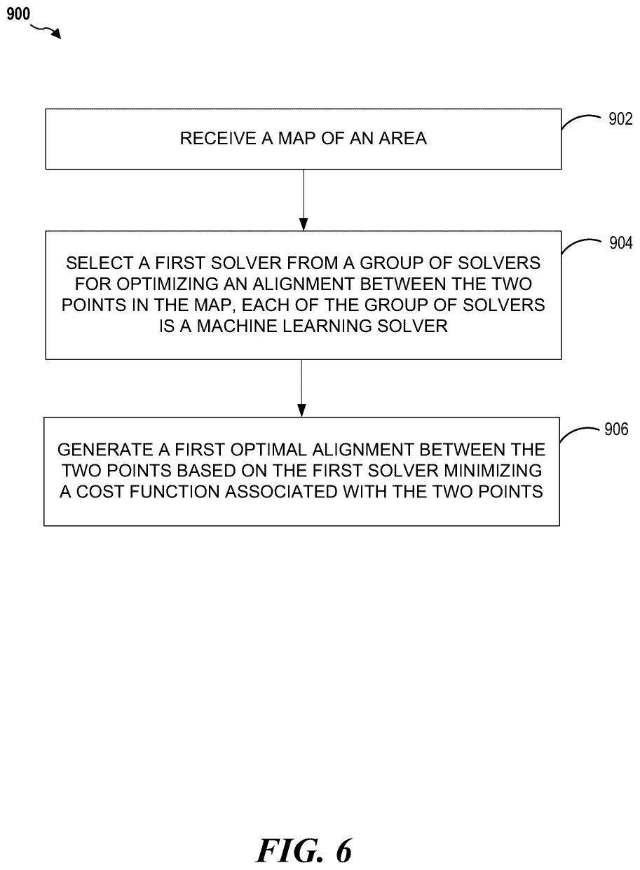

FIG. 6 is a flow diagram illustrating an example of a process 900 for optimizing an alignment between two points, in accordance with various aspects of the present disclosure. In some examples, the process 900 may be performed by the one or more components of the server 800 and/or the computing device 700. As shown in the example of FIG. 6, at block 902, the process 900 begins by receiving a map of an area. At block 904, the process 900 selects a first solver from a group of solvers for optimizing an alignment between the two points in the map, each of the group of solvers is a machine learning solver. At block 906, the process 900 generates a first optimal alignment between the two points based on the first solver minimizing a cost function associated with the two points.

The foregoing method descriptions and diagrams/figures are provided merely as illustrative examples and are not intended to require or imply that the operations of various aspects must be performed in the order presented. As will be appreciated by one of skill in the art, the order of operations in the aspects described may be performed in any order. Words such as “thereafter,” “then,” “next,” etc. are not intended to limit the order of the operations; such words are used to guide the reader through the description of the methods and systems described. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects described may be implemented as electronic hardware, computer software, or combinations of both. To clearly illustrate this interchangeability of hardware and software, various illustrative components, blocks, modules, circuits, operations, etc., have been described generally in terms of their functionality. Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc., described in connection with the aspects described may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk storage, magnetic storage smart objects, or any other medium that may be used to store program code in the form of instructions or data structures and that may be accessed by a computer. Disk as used may refer to magnetic or non-magnetic storage operable to store instructions or code. Disc refers to any optical disc operable to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined may be applied to other aspects without departing from the scope of the claims. Thus, the present disclosure is not intended to be limited to the aspects illustrated but is to be accorded the widest scope consistent with the claims disclosed.

1. A computer-implemented method for optimizing an alignment between two points, the method comprising:
receiving a map of an area;
selecting a first solver from a group of solvers for optimizing an alignment between the two points in the map, each of the group of solvers is a machine learning solver; and
generating a first optimal alignment between the two points based on the first solver minimizing a cost function associated with the two points.

2. The computer-implemented method of claim 1, the method further comprising:
benchmarking the first solver to generate benchmarking data; and
logging the benchmarking data.

3. The computer-implemented method of claim 1, the method further comprising:
selecting one or more second solvers from the group of solvers to optimize the first alignment by minimizing the cost function; and
generating based on the one or more second solvers a second optimized alignment.

4. The computer-implemented method of claim 1, wherein:
one or more locations in the map are associated with a respective cost; and
the first solver minimizes the cost function based on the respective cost of each location corresponding to a path between the two points.

5. The computer-implemented method of claim 1, wherein:
the map includes an initial alignment between the two points; and
the first optimal alignment optimizes the initial alignment.

6. The computer-implemented method of claim 1, further comprising pre-processing the map.

7. An apparatus for optimizing an alignment between two points comprising:
one or more processors; and
one or more memories coupled with the one or more processors and storing processor-executable code that, when executed by the one or more processors, is configured to cause the apparatus to:
receive a map of an area;
select a first solver from a group of solvers for optimizing an alignment between the two points in the map, each of the group of solvers is a machine learning solver; and
generate a first optimal alignment between the two points based on the first solver minimizing a cost function associated with the two points.

8. The apparatus of claim 7, wherein execution of the processor-executable code further causes the apparatus to:
benchmark the first solver to generate benchmarking data; and
log the benchmarking data.

9. The apparatus of claim 7, wherein execution of the processor-executable code further causes the apparatus to:
select one or more second solvers from the group of solvers to optimize the first alignment by minimizing the cost function; and
generate based on the one or more second solvers a second optimized alignment.

10. The apparatus of claim 7, wherein:
one or more locations in the map are associated with a respective cost; and
the first solver minimizes the cost function based on the respective cost of each location corresponding to a path between the two points.

11. The apparatus of claim 7, wherein:
the map includes an initial alignment between the two points; and
the first optimal alignment optimizes the initial alignment.

12. The apparatus of claim 7, wherein execution of the processor-executable code further causes the apparatus to pre-process the map.

13. A non-transitory computer-readable medium having program code recorded thereon for optimizing an alignment between two points, the program code executed by one or more processors and comprising:
program code to receive a map of an area;
program code to select a first solver from a group of solvers for optimizing an alignment between the two points in the map, each of the group of solvers is a machine learning solver; and
program code to generate a first optimal alignment between the two points based on the first solver minimizing a cost function associated with the two points.

14. The non-transitory computer-readable of claim 13, wherein the program code further comprises:
program code to benchmark the first solver to generate benchmarking data; and
program code to log the benchmarking data.

15. The non-transitory computer-readable of claim 13, wherein the program code further comprises:
program code to select one or more second solvers from the group of solvers to optimize the first alignment by minimizing the cost function; and
program code to generate based on the one or more second solvers a second optimized alignment.

16. The non-transitory computer-readable of claim 13, wherein:
one or more locations in the map are associated with a respective cost; and
the first solver minimizes the cost function based on the respective cost of each location corresponding to a path between the two points.

17. The non-transitory computer-readable of claim 13, wherein:
the map includes an initial alignment between the two points; and
the first optimal alignment optimizes the initial alignment.

18. The non-transitory computer-readable of claim 13, wherein the program code further comprises program code to pre-process the map.
